(19) United States
(12) Patent Application Publication
(10) Pub. No.: US 2008/0166682 A1
(43) Pub. Date: Jul. 10, 2008

(54) Unit For Holding Instruments and Components For Dental Treatment

(75) Inventors: Goran Bjorn, Onsala (SE); Hakan Olsson, Kullavik (SE); Lars Jorneus, Fillesas (SE); Anders Johansson, Goteborg (SE)

Correspondence Address: KNOBBE MARTENS OLSON & BEAR LLP, 2040 MAIN STREET, FOURTEENTH FLOOR, IRVINE, CA, 92614, US

(73) Assignee: Nobel Bicoare Services AG, Zurich-Flughafen (CH)

(21) Appl. No.: 11/813,207

(22) PCT Filed: Dec. 22, 2005
(86) PCT No.: PCT/SE2005/001996

§ 371 Date: Jun. 29, 2007

(30) Foreign Application Priority Data
Dec. 30, 2004 (SE) 0403199-3

(51) Int. Cl. A61C 19/02

(52) U.S. Cl. 433/77; 206/369

(57) ABSTRACT

A unit is provided for holding instruments and components that are used in dental treatment. The unit can comprise sides, a bottom, and a top that can be modular or integrally formed. The unit can have a drawer-shaped construction and can be made of heat-resistant material. The sides and bottom can form a first rigid unit part, all or part of which can be provided externally with a covering or layer of a non-rigid or flexible material. The covering or layer is arranged to be easy to hold and to have good frictional characteristics. The top can form a rigid second unit part that preferably contains an organized holding arrangement for the instruments and components. Accordingly, the unit can be heat-resistant, robust and easy to hold, and have good frictional characteristics to prevent it sliding on an underlying surface upon which the unit is arranged placed.

### CROSS-REFERENCE TO RELATED APPLICATIONS

This application is a U.S. National Phase of International Application No. PCT/SE2005/001996, filed Dec. 22, 2005, which claims priority to Swedish Patent Application No. SE 0403199-3, filed Dec. 30, 2004, each of which is hereby incorporated by reference in its entirety.

### BACKGROUND

1. Field of the Invention

The present invention relates to a self-contained unit for holding instruments and components intended for use in dental treatment.

2. Description of the Related Art

The use of units for holding surgical instruments and components that are to be used in various dental connections is already known. For this purpose, the unit can be arranged to hold instruments and components in order for these to be able to be used in the various treatment situations. The unit or units can be the shape of a drawer or box and, for example, can receive and hold various combinations and parts for the various treatment situations on a surface that faces towards the user. Reference can be made to the patent SE 513842, obtained by the same applicant as for the present patent application, and to U.S. Pat. No. 5,518,115 and U.S. Pat. No. 5,525,314 and to the references cited therein.

### SUMMARY OF THE INVENTION

In accordance with an aspect of at least one of the embodiments disclosed herein is the realization that there is need in the art for a unit that can work as a single unit or as a modular system that will ensure the optimal provision of instruments and components for the various dental treatment situations. In addition, another aspect of at least one of the embodiments disclosed herein is the realization that the total volume of the unit or of the modular system should be limited. For example, a reduction in volume of up to 50% in comparison to currently-known corresponding equipment could be achieved.

Further, the unit or units can be made of a material or have a covering that is easy to hold and can have excellent frictional characteristics in relation to an underlying surface so that during the removal of instruments and components from the respective unit or during the insertion of instruments and components into the respective unit, the unit will not tend to slide on the underlying surface which can otherwise make the removal or insertion of instruments or components more difficult.

In addition, the unit or units can be configured to hold the same or greater numbers of instruments and components. Indeed, the number of instruments and components on the market has a constant tendency to increase and the ease of selection of the instruments and components has been made considerably more difficult on account of the increasing assortment. This means that it can be difficult to select the correct instruments and components.

Therefore, in accordance with another aspect of at least one embodiment disclosed herein is the realization that there is a need for improved access to and organization of sets of instruments and components. Such an improvement can optimize the use of these instruments and components in different types of treatment and with different patients and for different treatments, for example, more general treatment, advanced treatment, specialist treatment, etc. Accordingly, each user may be able to select his assortment from a larger general assortment in a simple way. It must therefore be possible for display arrangements and information labels for recommended treatment stages and for stages carried out in a particular order to be available on or in association with the respective unit.

Some embodiments disclosed herein can also be used to facilitate double utilization of expensive tools. For example, in a modular embodiment, different parts of the unit can be assembled irrespective of whether one or more of the unit parts constitutes or represents a varied collection. Thus a side or top arrangement is to be provided with different or optional top arrangements, that can occur in different variants with regard to the instruments and/or components that are held or that can be held. It is therefore important that the unit or units meet these requirements and make possible the clearest possible arrangement for each user.

In other embodiments, the unit or units can be manufactured using an autoclave at high temperatures. In this regard, various embodiments can be constructed to withstand long periods of use without requiring intermediate service or replacement of parts. Further, the unit or units can have a robust construction in addition to being easy to hold due to frictional characteristics.

An object of the present invention, therefore, is to solve all or parts of the problems described above.

In accordance with some embodiments, the unit can be configured to include side and bottom portions that can form a rigid first unit part. The first unit part can be configured to be completely or partially provided externally with a covering or layer of a non-rigid, flexible, or soft material and can be arranged to be easy to hold and functional. In addition, a top of the unit can form a rigid second unit part that can preferably contain an organized holding arrangement for the instruments and components. In some embodiments, the unit can be constructed of a combination of rigid and flexible or non-rigid/soft material.

The different materials in each unit preferably ar able to withstand temperatures of approximately 135° C., which are encountered during sterilization of the instruments and the components in the unit. In a preferred embodiment, the sides and bottom can be encased in non-rigid or soft material, which can consist of an elastomer (such as silicone). The sides and bottom can be constructed of rigid plastic, but they can also be made of metal. The unit can be constructed with a lid that can be arranged to be removable.

In another embodiment, the unit can be configured to include a support at one end that can be unfolded and folded away. By means of the support, the top surface of the unit can be given an advantageous angle of inclination in relation to a user. The top can be made of metal or plastic and can be provided with labeling that can withstand the above-mentioned temperatures. The unit can be arranged with holes and/or openings for facilitating passage of sterilizing steam therethrough. In some embodiments, the unit can include a unit holding arrangement that can comprise rubber grommets arranged with holes, hook-shaped holding devices and snap-fit devices.

According to the embodiments disclosed herein, the reduction in volume of the unit can be considerable, and the unit can be easy to hold and have a good frictional resistance in relation to the underlying surface upon which the unit is arranged.

In an additional embodiment, the unit can comprise a modular system having a plurality of modular units. The modular units can be arranged in a box that is provided with a lid that can be opened and closed. The box can be configured to hold the modular units securely during, for example, transportation and storage. The modular units can have different breadths and different combinations of different sizes of modular units and can be used in association with the storage box. The respective units can be provided with labeling or information regarding dimensions, different treatment stages, different types of patient, etc.

Therefore, in some embodiments, the unit can be configured to have small external dimensions and hold a relatively large number of instruments and components. Further, the unit can have a construction that is robust and easy to hold, and in addition, can have good frictional characteristics in relation to the underlying surface upon which the unit can be arranged. The unit can comprise an advantageous combination of the rigid and soft materials as mentioned above, such that the rigid material provides robustness and the soft material makes the unit easy to hold and provides frictional characteristics. The unit can also be configured to provide extremely good display information and labeling that can withstand harsh environments in which the unit may be placed. In spite of this, the unit can utilize known technology and known materials. The unit can also comprise a modular system for several units and can be arranged with a common storage box for these.

### BRIEF DESCRIPTION OF THE DRAWINGS

The above-mentioned and other features of the invention disclosed herein are described below with reference to the drawings of the preferred embodiments. The illustrated embodiments are intended to illustrate, but not to limit the invention. The drawings contain the following figures:

FIG. 1 is a perspective view of an embodiment of a unit having a lid and holding devices configured to accommodate instruments and/or components.

FIG. 1a is a cross-sectional view of the lid and the unit of FIG. 1 illustrating a holding device with a drill inserted therein.

FIG. 1b is a cross-sectional view of the unit of FIG. 1 illustrating a gap intermediate the lid and sides of the unit for facilitating passage of sterilizing steam, with the lid in a closed position.

FIG. 1c is a cross-sectional view of the unit of FIG. 1 illustrating the lid in a closed position and permanent gaps or openings between the lid and sides for facilitating passage of sterilizing steam.

FIG. 2 is a side perspective view of a first unit part, in which is arranged a support that can be unfolded and folded away, according to an embodiment.

FIG. 2a is a side view illustrating an inclination of a top side of a unit in relation to an underlying surface when the support is in the folded-down position, according to another embodiment.

FIG. 3 is a partial perspective view of a first unit part that comprises or is constructed of a plastic material or metal and is also covered externally with elastomer or other soft material, according to an embodiment.

FIG. 4 is a perspective view of a storage box accommodating three modular units with different arrangements of holding device and with different breadths, according to another embodiment.

FIG. 5 is a perspective view of a bottom of a storage box and guide devices arranged therein, according to an embodiment.

FIG. 6 is a cross-sectional front view of an alternative embodiment of the guide device of a storage box illustrated to FIG. 5.

FIGS. 7-7b are schematic illustrations of different layouts for a holding arrangement on modular units having a first breadth, according to an embodiment.

FIGS. 8-8e are schematic illustrations of different layouts for holding arrangements for instruments and/or components, in which each modular unit is half the breadth of the modular units illustrated in FIGS. 7-7b, according to another embodiment.

FIG. 9 is a perspective view of a unit having a drawer-shaped construction of rigid plastic for sides and bottom thereof.

### DETAILED DESCRIPTION OF THE PREFERRED EMBODIMENTS

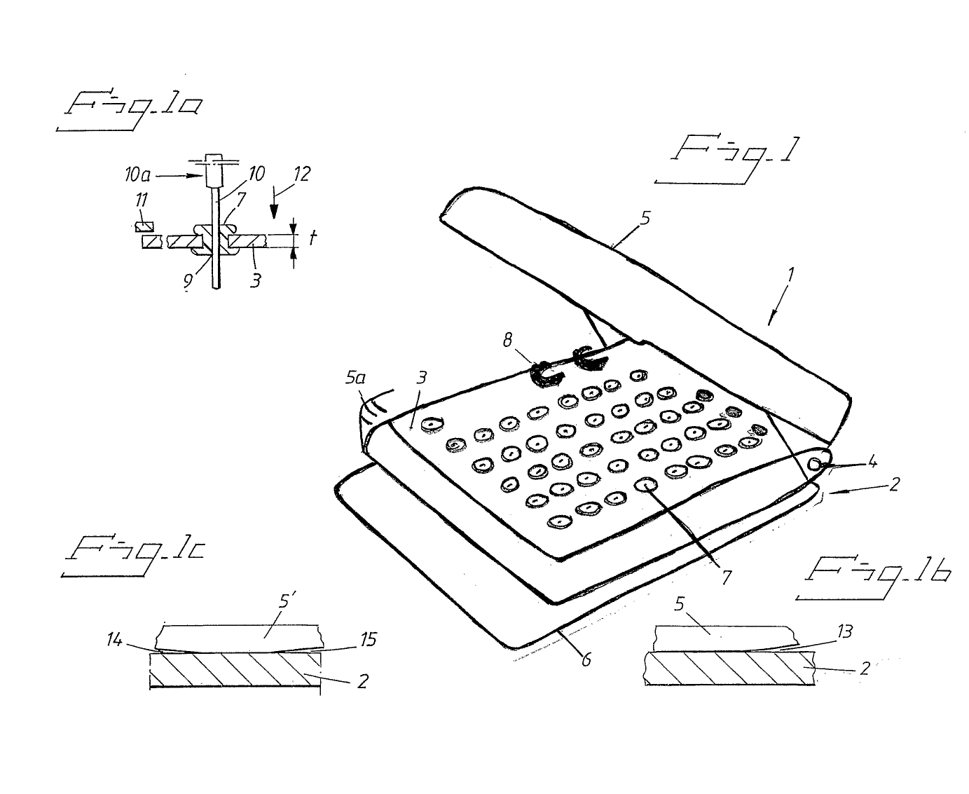

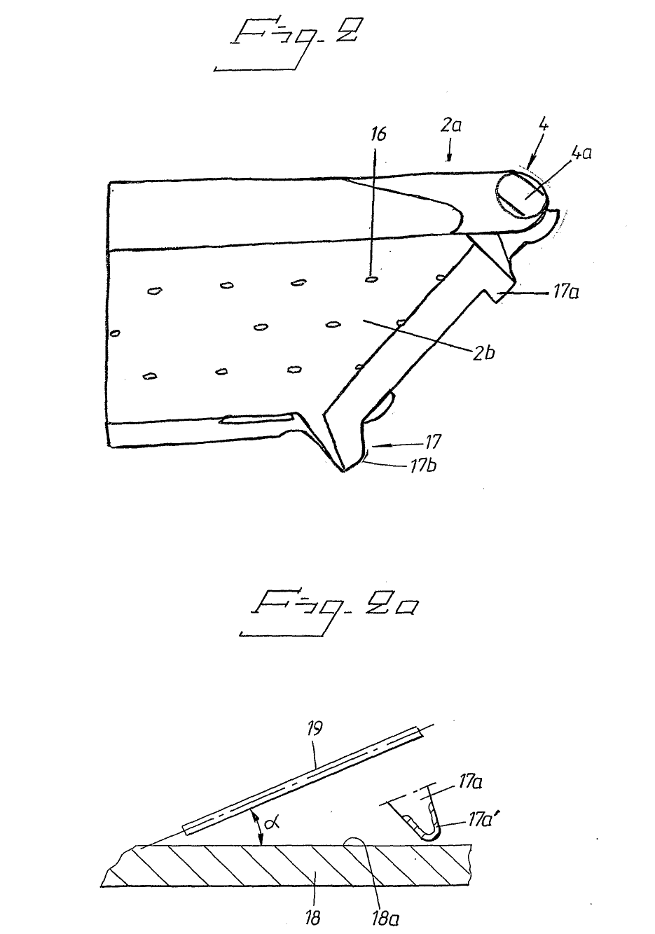

FIG. 1 illustrates an embodiment of a first module or modular unit 1. The modular unit 1 comprises a bottom, sides 2 and a top 3 arranged on these at the upper parts of the sides 2. In some embodiments, the unit 1 can be drawer-shaped. In the present embodiment, the sides can be arranged with a hinge rod 4 or corresponding hinge device. A lid 5 can also be connected to the modular unit 1 utilizing the hinge rod 4, which lid 5 can be mounted on the hinge rod 4 at its rear part. In FIG. 1, the lid 5 is shown in a partially opened position and can be put into a closed position that is indicated symbolically by element 5a.

In the closed position, the lid 5 covers the top 3 of the unit 1. FIG. 1 also illustrates that the unit 1 can be arranged on an underlying surface 6. In accordance with what is described below, the sides and bottom 2 can comprise a rigid drawer-shaped part that is covered externally with or encased in a soft material, which can comprise of elastomer, for example, silicone. The rigid drawer-shaped part can be constructed of rigid plastic, for example, polyethersulphone, polyphenylsulphone, or the like, or metal. The top 3 can be constructed of metal or rigid plastic, such as of the kinds mentioned above. The lid 5 can also be constructed of rigid plastic, such as of the kinds mentioned above. It is characteristic of the materials selected for use in the unit 1 that they can withstand high temperatures, for example 135° C., that are used during sterilizing or autoclaving. The top 3 can include holding devices of various kinds, which can comprise of rubber grommets 7, snap-fit devices 8, etc.

FIG. 1a shows an exemplary rubber grommet 7 in greater detail. The rubber grommet 7 can have a central hole 9, in which different components and/or tools can be inserted. A drill 10 is shown in FIG. 1, and its connection to a tool (not shown) has been indicated by 10a. The latter part is thus arranged to be able to be inserted into the opening 9. FIG. 1a also shows a thickness t of the top 3 that can be selected to be between 0.5-2.0 mm.

The top 3 can interact with snap-fit devices 11 on the said upper part of the sides 2. The top 3 is pushed downwards onto the sides in the direction of the arrow 12 so that the snap-fit function of the devices 11 is activated. Alternatively, the top 3 can be attached to the said upper parts of the sides 2 in a different way, for example by screws. The snap-fit devices 8 (see FIG. 1) can be constructed in a known way. The devices comprised in the holding arrangement are also constructed of material that can withstand the temperatures discussed above.

FIG. 1b is a cross-sectional side view of the unit 1 wherein the lid 5 is in its closed position in relation to the sides 2. In some embodiments, the design of the lid 5 can be such that there is a permanent gap 13 or opening or gaps or openings when the lid is in the closed position. The said gaps and/or openings can form a passage for the sterilizing steam during autoclaving.

FIG. 1c is another cross-sectional side view of the unit 1 in the closed position illustrating gaps or openings 14 and 15 between a front edge 5′ of the lid 5 when parts of the lid 5 make contact with the sides 2. The purpose of the lid 5, 5′ is to protect the instruments and/or components that are inserted in the holding arrangement during transportation, storage, etc. The lid 5 can be formed from transparent material that enables the set of instruments and/or components to be viewed from the outside of the unit 1.

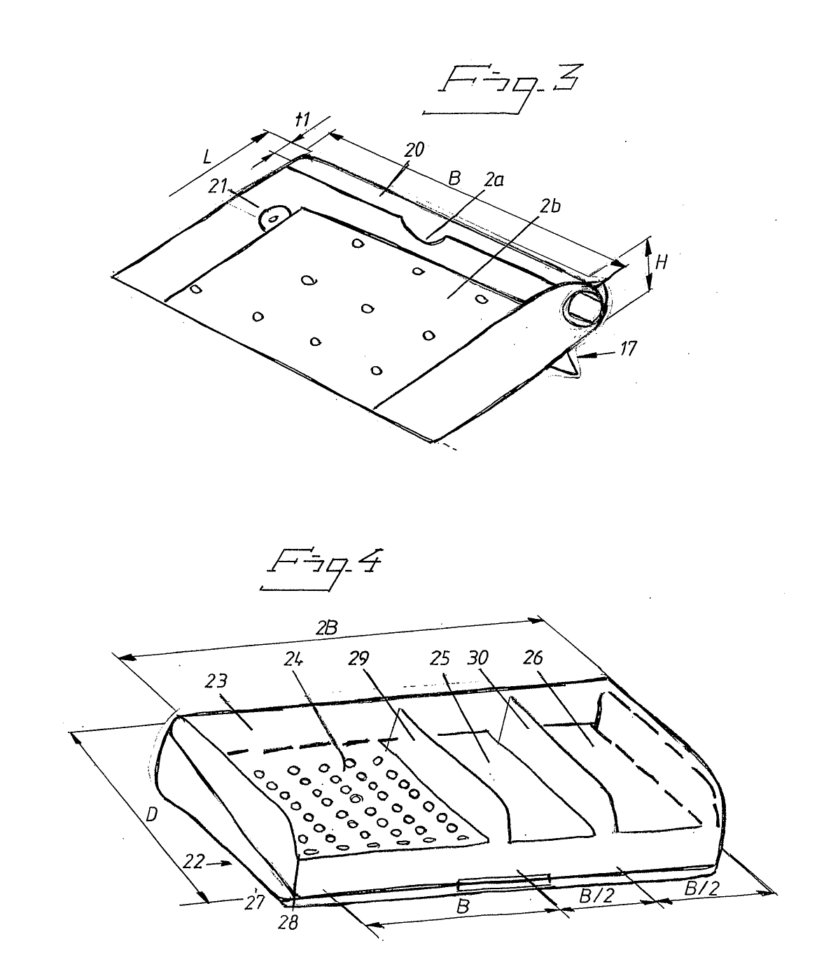

FIG. 2 is a cross-sectional side view of an exemplary embodiment of the unit 1 wherein sides 2a and a bottom 2b of the unit 1 are made of rigid plastic. The sides 2a and bottom 2b can form a first unit part. The sides 2a and bottom 2b can be formed as an integrated part during manufacture. Alternatively, the sides 2a and bottom 2b can be formed of two parts that can be assembled.

The embodiment of FIG. 2 shows the hinge device 4 in greater detail. The hinge device 4 can comprise a hinge rod that can be made of metal and that can extend through the sides 2a for the whole of their breadth. In the present embodiment, the hinge rod has projecting parts 4a on both sides of the unit 1. Accordingly, the lid 5 can be guided down over the hinge 4 and pivoted in different angles when in position, as shown by, for example, FIG. 1.

The embodiment of FIG. 2 also shows openings or holes 16 that can be arranged passing through the bottom 2b. The openings or holes 16 can form passages for sterilizing steam in association with autoclaving. In association with the sides 2a and bottom 2b, the unit 1 can also comprise a support 17 that can be unfolded and folded away, which support 17 can be provided with two feet 17a and 17b. With the support 17 in the folded-away position, the unit 1 can take up less space. However, with the support 17 in the unfolded position, as shown in FIG. 2, the top surface of the unit 1 can be inclined in relation to an underlying surface.

FIG. 2a illustrates an underlying surface 18 and a top 18a of the underlying surface 18. Additionally, a top surface 19 of the unit 1 is also shown in FIG. 2a and can be inclined towards a user, so that the user can see in an optimal way the surface and the instruments and/or components that are inserted in it. FIG. 2a shows the inclination in a longitudinal section through the unit 1. The support can be provided, for example, at least on its feet 17a, 17b, with a portion or layer of material that has good frictional characteristics that prevents the unit 1 sliding on the top 18a of the underlying surface 18 during insertion and removal of instruments and/or components. The angle of inclination is indicated by α in FIG. 2a and has, in the present illustration of FIG. 2a, been selected to be approximately 30°. The lid 5 can be arranged to hold inserted instruments and/or components securely during transportation and/or storage.

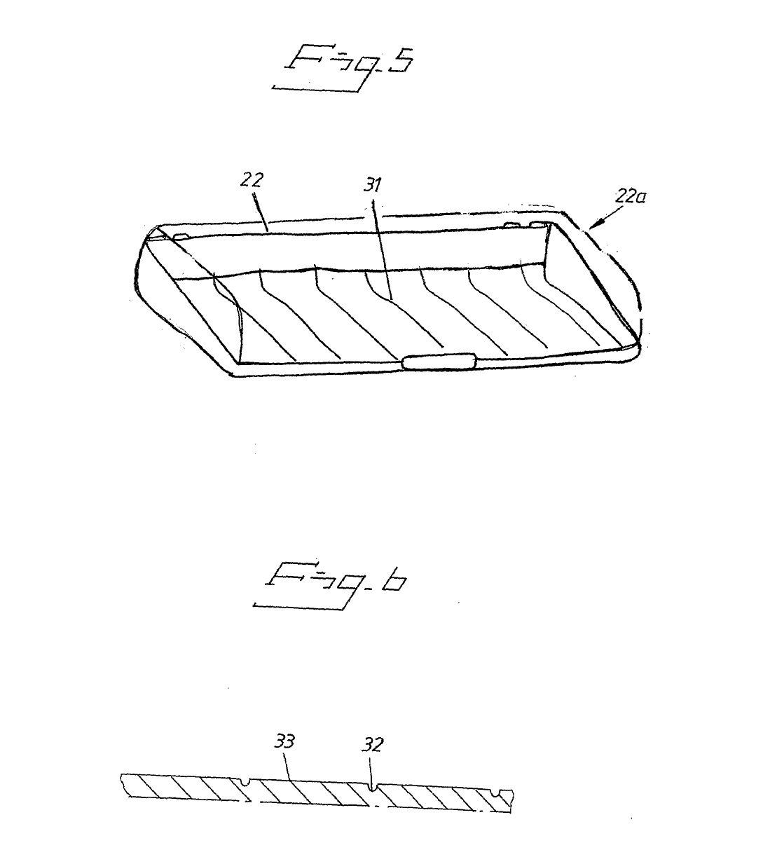

FIG. 3 is a perspective view illustrating the sides 2a and bottom 2b of the unit 1, which can comprise a second unit part. The second unit part can form the rigid drawer-shaped part. In the present embodiment, the sides 2a and the bottom 2b can be covered with a covering 20 of a soft material in accordance with what is described above. The process of applying the covering 20 and the encasing of the unit 1 can be carried out in a known way. The thickness and the Shore number constitute the parameters for the softness and the ease with which the unit 1 can be held. In some embodiments, a Shore number of 30-90, preferably 30-50, can be used. The thickness is indicated by t1 and can be selected to be between 30-50 mm and is preferably 20 mm.

In FIG. 3, a breadth of the unit 1 is indicated by B and a length of the unit 1 is indicated by L. The height of the unit 1 is indicated by H. As an example of the length L, it can be mentioned that this should lie within the range 150-200 mm, while the breadth B can have values within the range 150-200 mm. The height H can be selected within the range 30-50 mm.

FIG. 3 also illustrates a hinge arrangement 21 for the folding support 17. The hinge arrangement 21 can, for example, consist of a rod upon which the support is mounted in such a way that it can pivot, so that it can assume either of the unfolded or folded-away positions.

With reference now to FIG. 4, a plurality of modules or modular units 24, 25, and 26 can be arranged in a box-shaped drawer 22 with a lid 23 (shown as transparent) that can be raised and lowered. The breadth of the box 22 shown in FIG. 4 is indicated by 2B. In such a configuration, two modules with a breadth B can be arranged alongside each other in the box 22 shown in FIG. 4. Alternatively, as shown in FIG. 4, one modular unit 24 with breadth B can be arranged together with two modular units 25, 26 with half of the breadth of the modular unit 24, that is B/2.

In an alternative embodiment, the modular units 25 and 26 can be placed on each side of the modular unit 24, which then assumes a central position. The modular unit 24 (which can be referred to as the main module) and modular units 25 and 26 (which can be referred to as sub-modules) can be constructed as described above. However, the lids of the modules 24, 25 and 26 can be removed when the modules 24, 25, and 26 are placed in the storage box 22. The modules 24, 25, and 26 can thus be transported and/or stored in such a storage box 22. The modules 24, 25, and 26 are held securely in the box 22 when the lid of the box 22 is closed. The lid of the box 22 can also be configured to include permanent passages or openings 27, 28 when it is in its closed position. The openings 27, 28 can act as passages for sterilizing steam during autoclaving. The modules 24, 25, and 26 can be held securely in a lateral direction by means of supports 29, 30 that extend in the depth direction D of the box 22.

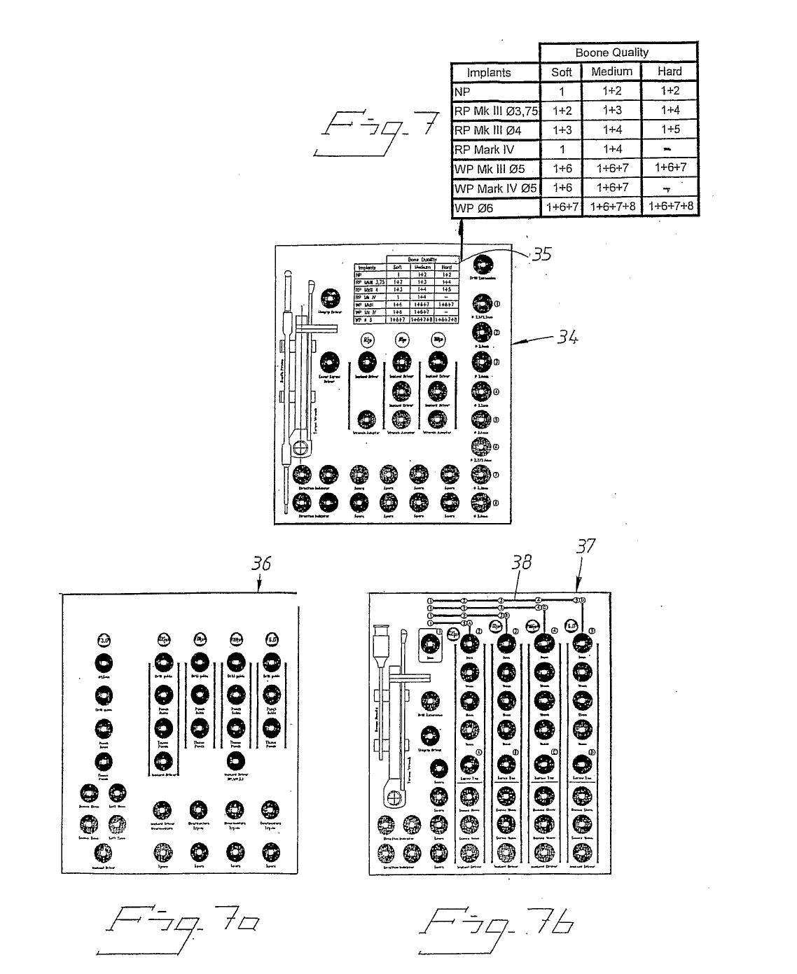

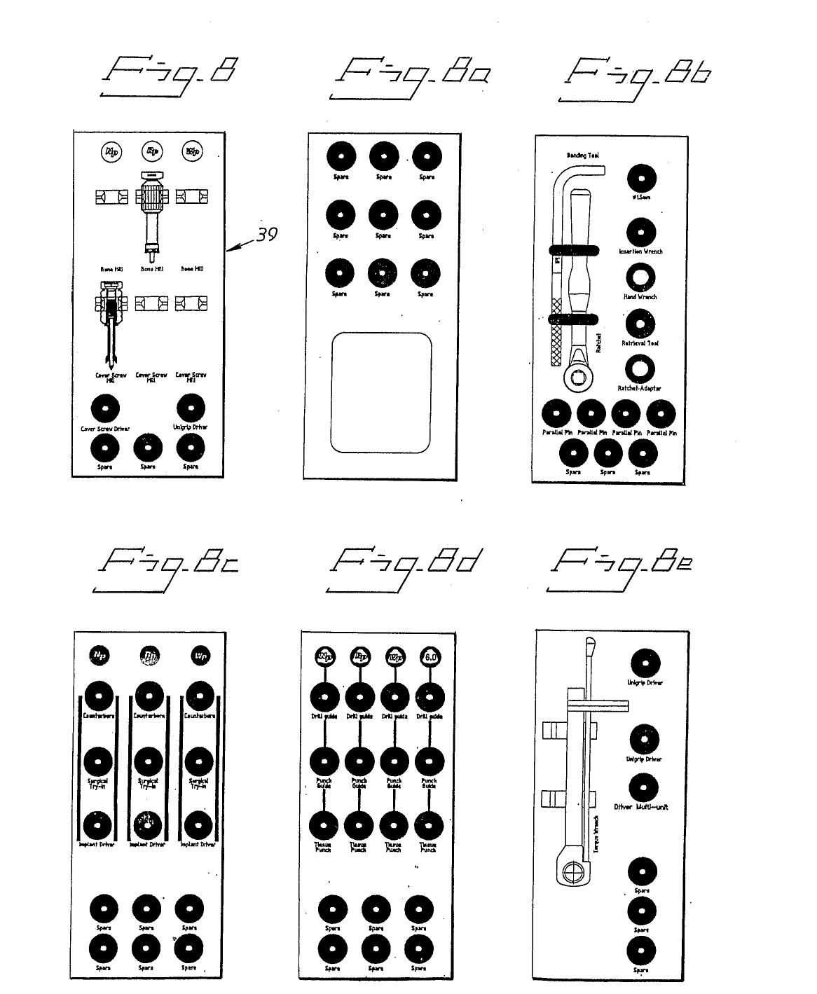

FIGS. 5 and 6 illustrate that in some embodiments, a box 22 can include a guide arrangement for modules or modular units that can be placed in the box 22. The guide arrangement can comprise guide ridges 31 arranged in the bottom 22a of the box 22 that extend in the direction D (see FIG. 4). Alternatively, in accordance with the cross-sectional view of FIG. 6, the guide ridges 31 can be designed as grooves 32 extending in the direction D. The bottom 22a can define surfaces 33 on which modular units can be placed. The box 22 can also be constructed of a heat-resistant material and can be constructed robustly in order to be able to protect the instruments and components in the modular units. The box 22 can be designed with rigid units constructed of metal or of the rigid plastic mentioned above. The box 22 can also be constructed or encased completely or partially in material that is easy to hold. The lid of the box 22 can be constructed of transparent material.

FIGS. 7, 7a and 7b show different examples of a holding arrangement for the main modules and display and information labels. The main modules can be selected with different layouts for instruments and/or components. In the example embodiment of FIG. 7, a table 35 can be provided on the main module 34 that can indicate which implants should be used for different bone qualities, such as for soft, medium and hard bone. The different holding devices can be numbered and, in addition, the types of implants can be listed in the table 35. By combining the instruments and/or components arranged in the different holding devices, different treatments can be carried out.

FIGS. 7a and 7b show two modified embodiments of arrangements, 36 and 37 respectively, of the holding devices. Different stages in the treatment can be indicated in the arrangements 36, 37. For example, the partial stages can be indicated by horizontal lines 38 that indicate the relevant instruments and/or components that are to be used in the different stages.

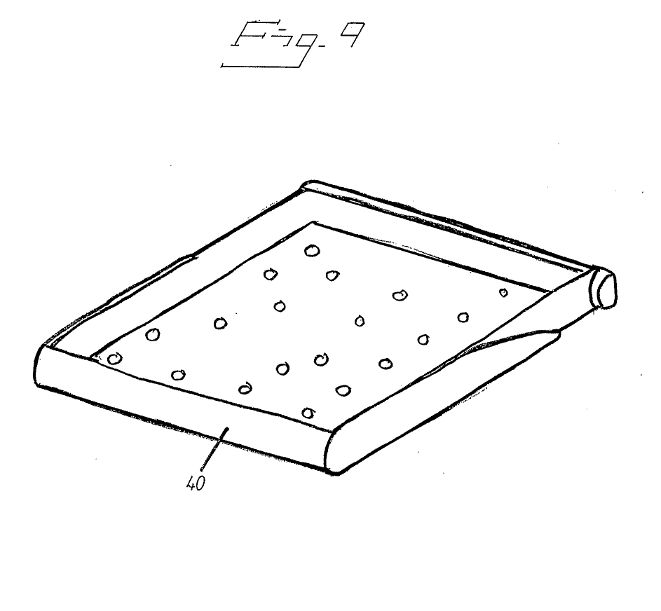

FIGS. 8-8e show different sub-modules and indications on these of the use, patient type, implant type, etc. The sub-modules are represented by the reference numeral 39. A sub-module can supplement the content of a main module and can represent, for example, a specialist stage or advanced stage in relation to the general directions and proposals that are provided by means of the main module. The space between the top and bottom of the main module can be utilized for the insertion of additional instruments and/or components, that can thereby be of a more bulky type.

FIG. 9 shows a drawer-shaped construction of the sides and bottom of a unit. In order to make the above-mentioned covering or encasing on the outside of the parts adhere more securely, the drawer-shaped construction can be designed with a corrugated arrangement 40 that extends vertically on the outside of the parts in question. As a result of the applied soft material extending into the corrugations, the whole covering can be prevented from moving in relation to the sides. Grooves or corrugations (not shown) in a horizontal direction can prevent the vertical movement of the covering in relation to the outside of the sides. In addition or alternatively, the covering can be secured at the upper edge of the sides.

The invention is not limited to the embodiments shown above as examples, but can be modified within the framework of the following claims and concept of the invention.

1-28. (canceled)

29. A unit for holding instruments and components intended for use in dental treatment, the unit comprising:
a first unit part comprising sides and a bottom, the sides having lower ends and upper ends, the bottom being oriented generally horizontally, the sides extending generally vertically with the lower ends thereof being attachable to the bottom to form the rigid first unit part;
a soft layer of material being at least partially disposed on the first unit part; and
a second unit part comprising a top, the top having a top surface and an organized holding arrangement comprising at least one hole being disposed on the top surface, the hole being sized and configured to receive and support one of the instruments and components therein, the second unit part being attachable to the first unit part adjacent the upper ends of the sides thereof,
wherein the first and second unit parts are fabricated from heat-resistant materials for withstanding high temperatures during sterilization.

30. The unit of claim 29, wherein the sides and bottom of the first unit part are integrally formed as a self-contained unit.

31. The unit of claim 29, wherein the first unit part has a drawer-shaped construction.

32. The unit of claim 29, wherein the unit is configured to withstand temperatures of at least 135° C.

33. The unit of claim 29, wherein the layer of material extends over both the sides and bottom of the first unit part.

34. The unit of claim 33, wherein the sides and bottom are substantially encased in the layer of material.

35. The unit of claim 29, wherein the layer of material is an elastomer.

36. The unit of claim 29, wherein the sides and bottom are made of rigid plastic.

37. The unit of claim 29, wherein the first unit part includes a hinge arrangement for accommodating a lid with the unit.

38. The unit of claim 29, wherein first unit part are arranged with a support at one end, the support being configured to be unfolded and folded away, the support being configured to position the unit at an angle of inclination in relation to an underlying surface upon which the unit is placed for facilitating access to instruments and components when placed in the unit.

39. The unit of claim 29, wherein the top is attachable to an upper part of the sides via a snap-fit.

40. The unit of claim 29, wherein the top is made of one of a metal and a plastic, the top having labeling that is heat-resistant.

41. The unit of claim 29, wherein the bottom includes holes disposed therein for facilitating passage of sterilizing steam.

42. The unit of claim 29, wherein the unit further comprises a lid being configured to define lateral openings intermediate the lid and the first unit part for facilitating passage of sterilizing steam when the lid is in a closed position.

43. The unit of claim 29, wherein the holding arrangement of the top of the second unit part comprises at least one hole and a rubber grommets mounted in the hole, the rubber grommet having a hole being sized and configured to receive one of the instruments and components.

44. The unit of claim 29, wherein the holding arrangement comprises hook-shaped holding devices and snap-fit devices for instruments and components.

45. The unit of claim 29, wherein the layer of material has a Shore number of approximately between 30-90.

46. The unit of claim 29, wherein the layer of material has a thickness of approximately 1-2 mm, the layer of material being arranged with an intermediate gap between the layer of material and at least one of the sides and bottom of the first unit part for improving characteristics of ease of holding and frictional characteristics.

47. A modular system for holding instruments and components intended for use in dental treatment, the system comprising:
a plurality of modular units comprising:
a first unit part comprising sides and a bottom, the sides having lower ends and upper ends, the bottom being oriented generally horizontally, the sides extending generally vertically with the lower ends thereof being attachable to the bottom to form the rigid first unit part;
a soft layer of material being at least partially disposed on the first unit part; and
a second unit part comprising a top, the top having a top surface and an organized holding arrangement comprising at least one hole being disposed on the top surface, the hole being sized and configured to receive and support one of the instruments and components therein, the second unit part being attachable to the first unit part adjacent the upper ends of the sides thereof; and
a storage box being sized and configured to removably receive a plurality of modular units therein for facilitating access to the modular units;
wherein at least the first and second unit parts are fabricated from heat-resistant materials for withstanding high temperatures during sterilization.

48. The system of claim 47, wherein each modular unit has a length of approximately 150-200 mm, a breadth of approximately 150-200 mm and a height of approximately 30-50 mm.

49. The system of claim 47, wherein each modular unit defines a breadth and a collective breadth of modular units inserted in the box correspond to a breadth of the box.

50. The system of claim 47, wherein the box includes lateral and vertical guides configured to facilitate placement of modular units therein.

51. The system of claim 50, wherein at least one of the lateral and vertical guides of the box are configured as one of grooves and ridges extending in the longitudinal direction of the modular units.

52. The system of claim 47, wherein the system includes at least three modular units and a plurality of the modular units have different breadths.

53. The system of claim 47, wherein each modular unit includes an informational diagram on the second unit part of the modular unit, the informational diagram providing information related to instruments and components utilized for treatment of a patient.

54. The system of claim 47, wherein a selected modular unit is combinable with another selected modular unit to optimize organization of instruments and components for treatment of the patient.
